(19) United States
(12) Patent Application Publication
(10) Pub. No.: US 2003/0121042 A1
(43) Pub. Date: Jun. 26, 2003

(54) Guide with PVR scheduling links

(75) Inventors: Kenneth A. Franken, Iowa City, IA (US); Toufic Moubarak, Iowa City, IA (US); Jack Perry, Cedar Rapids, IA (US)

Correspondence Address: SIMMONS, PERRINE, ALBRIGHT & ELLWOOD, P.L.C., THIRD FLOOR TOWER PLACE, 22 SOUTH LINN STREET, IOWA CITY, IA, 52240, US

(73) Assignee: DECISIONMARK CORP.

(21) Appl. No.: 10/269,467

(22) Filed: Oct. 11, 2002

Related U.S. Application Data
(63) Continuation-in-part of application No. 09/681,275, filed on Mar. 12, 2001.
Application No. 09/681,275 is a continuation-in-part of application No. 09/538,215, filed on Mar. 30, 2000, now Pat. No. 6,252,547.

(51) Int. Cl. G06F 3/00; H04N 5/445; G06F 13/00

(52) U.S. Cl. 725/51; 725/39; 725/44

(57) ABSTRACT

A computer and internet-based system and method for programming a PVR to record a particular program on an on-line programming guide, where clicking on a link in a cell in the program guide provides to a PVR or image viewer a standardized set of instructions directing the PVR or image viewer to record or display the program associated with the programming guide cell.

### CROSS REFERENCE TO RELATED APPLICATIONS

This application is a continuation-in-part (CIP) application of and relates to co-pending application entitled “GUIDE WITH PROGRAM DELIVERING LINKS” having Ser. No. 09/681,275, filed on Mar. 12, 2001, which is itself a continuation-in-part application of and relates to U.S. Pat. No. 6,252,547 entitled “METHOD AND APPARATUS FOR LIMITING ACCESS TO SIGNALS DELIVERED VIA THE INTERNET”. This application also is related to co-pending application entitled “METHOD AND SYSTEM FOR PROVIDING HOUSEHOLD LEVEL TELEVISION PROGRAMMING INFORMATION”, having Ser. No. 09/681,171, which was filed on Feb. 8, 2001, and assigned to the same assignee. This application also is related to co-pending application entitled “INDIVIDUALIZED CONTENT GUIDE”, Ser. No. 09/681,172, which was also filed on Feb. 8, 2001, and assigned to the same assignee. The above-referenced applications are incorporated herein in their entirety by these references.

### FIELD OF THE INVENTION

The present invention generally relates to computers, and more particularly relates to computer-assisted delivery of television programming information, and even more particularly relates to methods and systems for delivering television program information to a PC to facilitate programming a personal video recorder (PVR) in an easy and efficient manner.

### BACKGROUND OF THE INVENTION

In recent years, with the proliferation of sources of television programming including conventional terrestrially broadcast TV, cable TV, and satellite-delivered TV, often an overwhelming number of programming choices exist for a consumer. Consumers often desire to have a guide which only shows the programming choices available at various selected time slots. The magazine, TV Guide, is one well-known example of such a printed programming guide.

TV Guide Online is an example of a web-based programming guide which provides a user with a programming list which is configurable using drop-down boxes or links to enable customers to switch or sort the content of the display to another source; e.g. from cable only to broadcast only, etc. Another variant of TV Guide Online is delivered to the customer over the customer's cable TV connection.

While such web-based programming guides have enjoyed success in the past, they have some drawbacks. First of all, the web-based TV Guide Online generally requires the user to switch from a computer to a video cassette recorder (VCR) or a Personal Video Recorder (PVR) and to remember the channel number, start and stop times and more importantly, remember the particular procedure necessary to program the recorder to record a television program in the future. Some PCs have had PCTV boards therein which allow a PC user to watch television and to record programs, but the TV Guide Online user would still be required to switch between computer programs (one for viewing TV and another for browsing the internet), then remember the channel, start and stop time, and then program the PCTV board to record the correct channel at the desired time. The TV Guide Online programming guide, which is delivered along with cable TV services, does not provide any information to a PC, and it does not provide information to cable users about broadcast stations unless they are included in the package of channels delivered via cable TV.

Other systems exist which provide for recording of television programming. TiVo, Replay TV and Ultimate TV are examples of digital television recorders. However, these systems are generally associated with television sets and not with PCs and PCs having PCDT or PCTV cards therein.

Guide Plus (Gemstar) is an Internet-enabled, but not web-based, program guide that provides PVR integration with ATI PCTV cards. It is believed to require custom driver modules to support additional PCTV cards.

Guide Plus is also believed to be a Windows-only program. Guide Plus is an “off-line” program guide that stores data locally and only goes on-line to get data updates.

Consequently, there exists a need for improved methods and systems for facilitating the selection and programming of a video recorder in an easy and efficient manner.

### SUMMARY OF THE INVENTION

It is an object of the present invention to provide a system and method for providing TV programming information to a video recorder in an efficient manner.

It is a feature of the present invention to include a PC coupled to a television tuner and having PVR software and to program or schedule the PVR software to record a particular future program when a viewer, using a web-based program guide, clicks on a PVR icon in a program listing for that particular future program.

It is an advantage of the present invention to achieve improved efficiency in delivery of programming and programming information to PC users.

It is another advantage of the present invention to provide for a clean separation between the production of scheduling data and the use of that data by numerous users working on varied browsers, operating systems and hardware platforms.

The present invention is an apparatus and method for programming a video recorder, which is designed to satisfy the aforementioned needs, provide the previously stated objects, include the above-listed features, and achieve the already articulated advantages. The present invention is carried out in a “wasted time-less” manner in a sense that the time consumed by a PC user in transferring web-based programming information to a PVR and programming thereon a future program to be recorded, has been greatly reduced. The time spent by video recorder manufacturers to support recording from a web-based program guide is also reduced.

Accordingly, the present invention is a system and method for scheduling or programming a video recorder to record programs listed on an on-line programming guide, PVR software associated with the video recorder which recognizes and utilizes for programming the video recorder, a standardized scheduling message format provided by an on-line programming guide.

### BRIEF DESCRIPTION OF THE DRAWINGS

The invention may be more fully understood by reading the following description of the preferred embodiments of the invention, in conjunction with the appended drawings wherein:

FIG. 1 is a simplified view of a system of the present invention, which PC of the present invention has a PCTV board and has a programming guide display thereon, with the PVR icon displayed therein.

FIG. 2 is a simplified view of a display screen of the programming guide of the present invention, which includes the PVR icon.

FIG. 3 is a simplified view of the structure of the system of the present invention.

FIG. 4 is a simplified view of the interface between an internet browser containing the programming information, a television tuner card, and various other application software.

### DETAILED DESCRIPTION

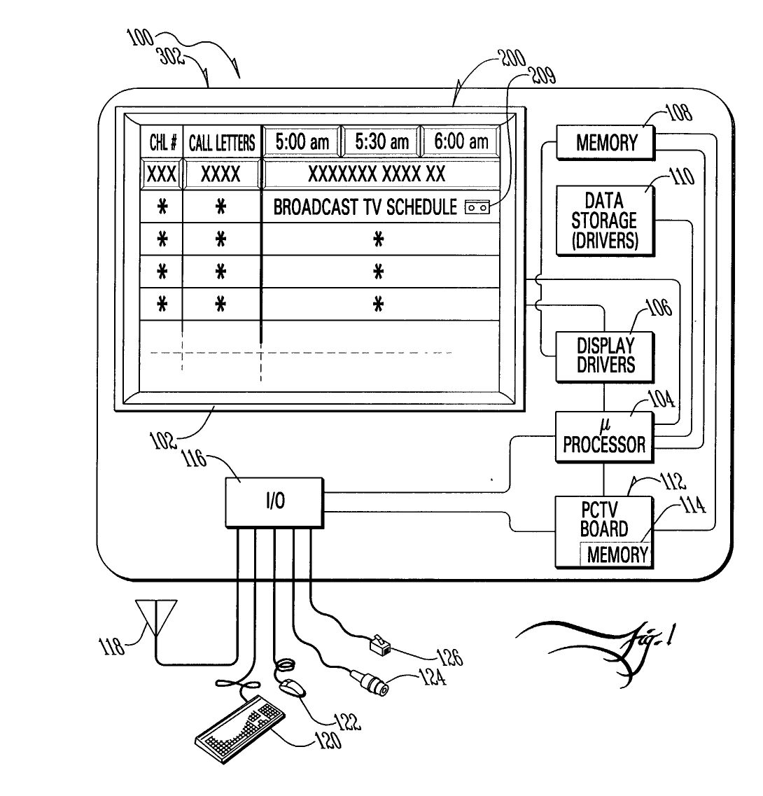

Now referring to the drawings wherein like numerals refer to like matter throughout, and more specifically referring to FIG. 1, there is shown a system generally designated 100, which includes a user PC 302, which includes a PC display device 102, which could be any type of display device capable of viewing web pages or portions thereof PC display device 102 is coupled to microprocessor 104 and display drivers 106 in a well-known manner. Microprocessor 104 has coupled thereto: a memory 108, data storage drivers 110, and a PCTV expansion board 112. PCTV expansion board 112 can be an ISA, PCI or other type of expansion card, or it may be any type of circuitry which performs the function of tuning a television receiver within a PC. Throughout this document, PCTV expansion board 112 shall be read to include any type of device, software or circuitry which is coupled to a PC either internally as an expansion card or externally as through a USB or other port. PCDT expansion board should also be read to include conventional television or video cassette recorder coupled to a PC via a computer controlled infrared remote or similar device. It is expected that in the future, TV tuner functionality may be added to motherboards, much like Ethernet support has moved from expansion cards to motherboards. (At this point, it is both a PC with TV and a TV with computer). PCTV expansion board 112 (501 in FIG. 4) may have a PCTV board memory section 114 (driver 502 in FIG. 4) therein which includes dedicated memory. The “driver” may be in two pieces: an optional or standard on-board “firmware” piece; and an operating system driver. The first may be resident on the board, and the latter may be resident in main memory. An input/output function 116 is shown in FIG. 1 as coupling various external devices and/or I/O devices, such as broadcast television antenna 118, mouse 122, coaxial antenna cable 124, network connection jack 126, and keyboard 120. These may be coupled to the microprocessor 104 or the other components in any functional manner. Coaxial antenna cable 124 can be coupled to a source of cable television (CATV) or a satellite receiver or other source of television signals.

In general, PCTV expansion board 112 can be used to receive television signals from either broadcast television antenna 118 or coaxial antenna cable 124 or other source. PCTV expansion board 112 actually demodulates the television signal, just as would a receiver in a conventional television set. The demodulated signal is then provided to the PC display device 102 with the assistance of microprocessor 104 and display drivers 106 and other related hardware and software where appropriate. PCTV expansion board 112 preferably is an off-the-shelf PCTV expansion card.

It should be understood that all of the client-side components (PC, PCTV board, PVR software, browser, etc.) are commercially available. For the purposes of this description, the PC, for example, may be a black box. The present invention is not intended to be limited to how a particular PC works; in fact, there could be major architectural changes to the PC, and it should not affect the present invention.

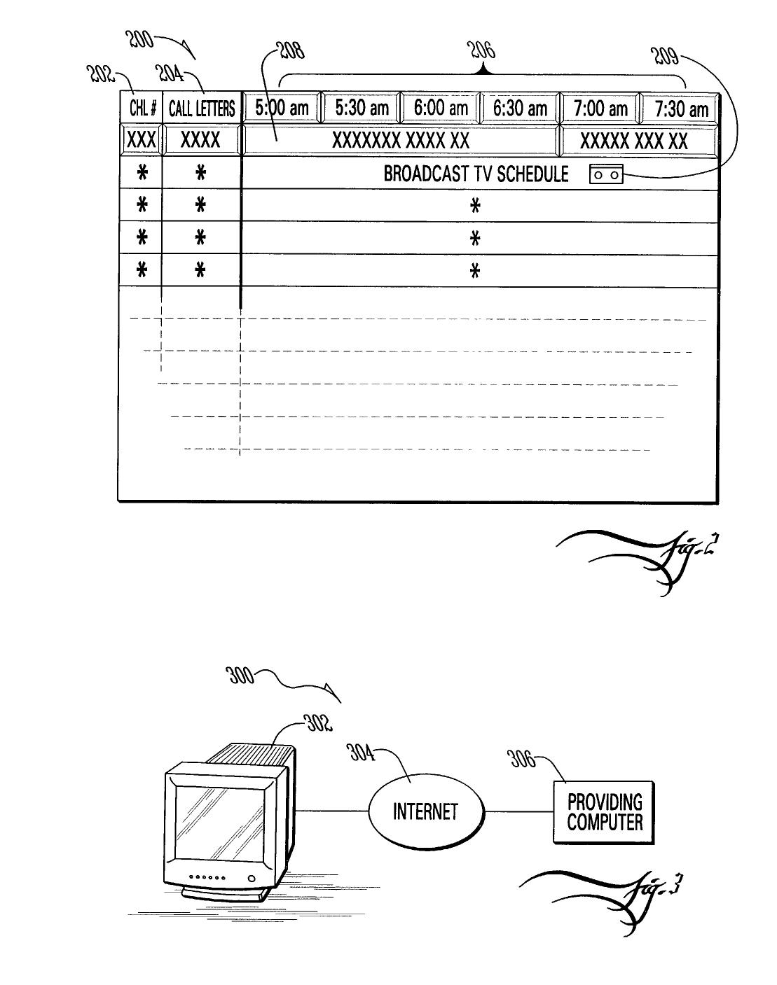

Now referring to FIG. 2, there is shown a program guide of the present invention generally designated 200, having a channel number column 202, call letters column 204, and a plurality of time slot columns 206. Also shown is a programming cell 208 which is disposed in one of the time slot columns 206 and is associated with a particular channel number. Programming cell 208 includes information therein relating to a program which is associated with a particular time slot column and a particular channel number. More specifically, programming cell 208 may be in the form of a hypertext link which, when clicked by a user of user PC 302, will result in a detailed description of the program being displayed on the PC display device 102. Additionally, programming cell 208 may include an icon 209, which, when clicked, programs the virtual VCR application 701 (FIG. 4), to record the program whose listing is displayed in the programming cell 208. Virtual VCR application 701 will be referred to throughout this discussion as “PVR software” or “PVR application”. The PVR software is well known in the art and is commercially available from numerous suppliers of PCTV boards such as the PCTV board 112 shown in FIG. 1. Icon 209 is shown as resembling a VCR tape; however, any type of icon could be used as well.

This act of clicking on icon 209 in a programming cell 208 of a programming guide and thereby automatically scheduling for later recording the program listed in that programming cell 208, is a key aspect of the present invention.

There are numerous ways that the scheduling for recording of a selected program could be automated. One way of achieving this result will be described below while referring to FIGS. 1, 3, and 4.

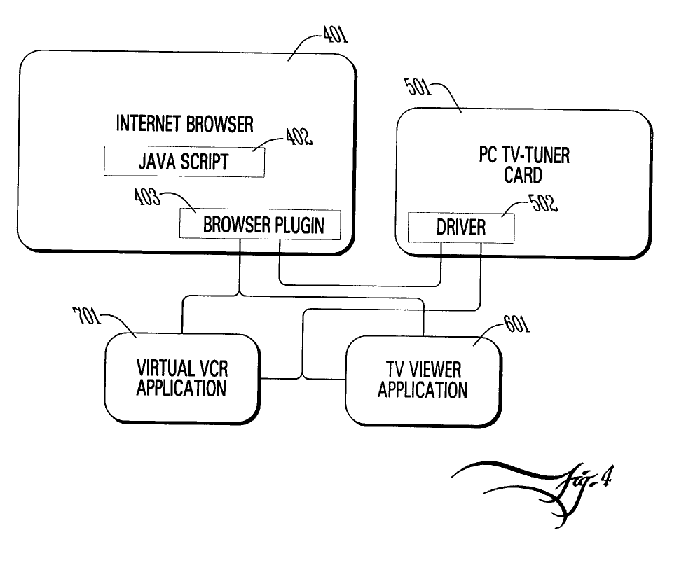

First of all, when a user clicks on the icon 209, the browser 401 on PC 302 (which browser is well known in the art and can reside in memory 108, on data storage 110 and be executed by microprocessor 104) sends a request to the World Wide Web (WWW) server (the providing computer 306 of FIG. 3) hosting the program guide application [To clarify: the WWW server hosts the application that produces the HTML/JavaScript/TVPI documents. The HTML document is sent to the browser which renders it to produce the program guide 200]. The WWW server responds over the Internet 304, sending a TVPI document for the specific program requested to the client browser 401 on PC 302. The HTTP response that contains the TVPI document has a MIME content-type header of “application/x-tv-program-info”. The browser 401 looks at the content-type header (or the .TVPI file extension, depending on the type of browser) and sees that it is not a built-in type and looks for a registered browser helper application. The browser 401 finds that PVR software, i.e., the virtual VCR application 701, is associated with this content header type. The browser 401 then launches the PVR software and sends the TVPI document to the PVR software which reads the TVPI document and schedules the selected program for later recording.

This notion of a browser sending certain pre-registered document types to helper applications is well known in the art. For example, it is common for many browsers to not directly open .pdf documents. Instead, the browser recognizes the document type, launches an Acrobat Reader program, which opens and processes the document for viewing. There is a variety of methods (ActiveX controls, Netscape-style browser plugins, etc.) for dealing with special document types. All are well known in the art, and the choice of which method to use is dependent on many factors, including the desired degree of browser integration and the number of supported browsers desired. The approach described above (registered browser helper application) is supported by many of the popular browsers and is believed to be the simplest to implement.

The above description describes a request to a distant WWW server for the TVPI document upon clicking the icon 209. It should be understood that an alternative approach would be to include all of the information necessary to produce the TVPI document with each program cell 208 at the time the program guide 200 is initially downloaded. While this may result in slower download times for the guide as a whole, it would speed up the process of scheduling a selected program after the program guide has been downloaded. In such cases, a Java script 402 or other applet, etc. could be used to produce the TVPI document when the icon 209 is clicked. This approach would be very useful if, for example, the client PC were programmed to request several days' worth of HTML pages at once for subsequent offline operation.

In the present invention, the PVR software 701 is launched by the browser 401; however, the TVPI document could be directed to a TV viewer application 601, which could display a textual or graphic notification of the current programming available, and/or tune to the channel upon which the selected program will be provided. This may be done when the start time for recording is within a predetermined time period. Numerous variations of the present invention are anticipated and are intended to be covered by the claims below.

Now referring to FIG. 3, there is shown a simplified view of the system 300 of the present invention, including user PC 302, internet 304 and programming guide providing computer 306. There would be well-known internet connections connecting the user PC 302 and the programming guide providing computer 306 with the internet 304.

Another method of delivering television programming to the PC display device 102 is in response to clicking a hypertext link in a programming cell 208 and merely linking the programming cell to a web address that is streaming the desired programming. It is expected that in the future as broadband connections become more commonplace, television programming will be more available from sites on the internet. Currently, with the use of software by Real Video or others, limited live television programming, generally news and weather and generally not network programming, is available from a few stations. It is anticipated that more programming—including network programming, sports, movies, etc.—will be available. The system and method for scheduling a PVR as described herein would be equally applicable to such programming delivery means.

One of the key aspects of the present invention is the novel idea of providing a document with a registered MIME type and/or registered document extension in a predetermined standardized format to communicate the details necessary to automate the scheduling for recording by PVR software. It should be understood that documents with other MIME types or extensions, and documents which are formatted differently, could be used. The details described below are intended to be merely exemplary of the many various documents which could be used to automate the scheduling of PVR software.

### Message Format

The document will preferably consist of valid XML. The root node of the document will carry the same name as the MIME type of the document and will have a version number (1.0) as an attribute; i.e., <x-tv-program-info version=“1.0”>. The body of the XML document will consist of one or more program elements; each “program” element represents scheduling information for one television program. “Program” elements will contain the tokens defined below as text nodes.

### Tokens

The WWW Server 306 will send a document with one or more of the tokens described in the table below. The receiving application must assume no particular order of the tokens in the document. All times and dates are 24 hour UTC.

| | | Possible |
|---|---|---|
| Token | Description | values/comments |
| program | The root element for a | This node contains all |
| | single program information | the tokens listed below. |
| | descriptor. Several program | |
| | nodes may appear in the | |
| | same document. | |
| station | Station call sign | Any valid call sign |
| tv-mode | Indicates the type of service | digital, analog, cable, |
| | via which the requested | dbs-satellite, or datacast |
| | program is broadcast. | |
| program- | The name of the program, | Any string. |
| title | show or movie as shown on | |
| | WWW server 306 | |
| program- | The description as provided | Any string. |
| description | on WWW server 306 | |
| start-date | The date when the program | 8-digits formatted as |
| | starts | ccyymmdd |
| start-time | The time when the program | 5 characters formatted |
| | starts | as hh:mm |
| duration | The duration of the program | 5 characters formatted |
| | | as hh:mm. |
| end-date | The date when the program | See start-date |
| | will end | |
| end-time | The time when the program | See start-time. |
| | will end | |
| rf-channel | The RE channel over which | Valid RF channel |
| | the program is broadcast. | number |
| | Paired with the tv-mode | |
| | above, should help the | |
| | PCDT tuner. | |
| stream-number | This should help the tuner | Valid stream value. |
| | select the proper stream in | Only supplied when tv- |
| | case of digital broadcast. | mode value is digital or |
| | This value may be different | datacast. |
| | from psip-minor. | |
| psip-major | The major channel number | Valid integer. |
| | is as described in ASTC | Only supplied when tv- |
| | A/65 document and | mode value is digital or |
| | provided by WWW server | datacast |
| | 306 | |
| psip-minor | The minor channel number | Valid integer 0-999 |
| | is as described by ASTC | Only supplied when tv- |
| | A/65 document. | mode value is digital or |
| | | datacast |

### XML EXAMPLES

Analog Packet
<tv-program-info version=“1.0”>

<program>

<station>WKPT</station>
<rf-channel>5</rf-channel>
<tv-mode>analog</tv-mode>
<program-title>Friends</program-title>
<program-description>

Description, if any, goes here.

</program-description>
<start-date>20010512</start-date>
<start-time>15:30</start-time>
<end-date>20010512</end-date>
<end-time>16:00</end-time>
<duration>00:30</duration>

</program>

</tv-program-info>
Digital Packet
<tv-program-info version=“1.0”>

<program>

<station>WKPT-DT</station>
<rf-channel>43</rf-channel>
<stream-number>1</stream-number>
<tv-mode>digital</tv-mode>
<program-title>Friends</program-title>
<program-description>

Description, if any, goes here.

</program-description>
<start-date>20010512</start-date>
<start-time>21:00</start-time>
<end-date>20010512</end-date>
<end-time>21:30</end-time>
<duration>00:30</duration>
<psip-major>5</psip-major>
<psip-minor>1</psip-minor>

</program>

</tv-program-info>
Analog Packet -- Multiple Programs
<tv-program-info version=“1.0”>

<program>

<station>WKPT</station>
<rf-channel>5</rf-channel>
<tv-mode>analog</tv-mode>
<program-title>Friends</program-title>
<program-description>

Description, if any, goes here.

</program-description>
<start-date>20010512</start-date>
<start-time>15:30</start-time>
<end-date>20010512</end-date>
<end-time>16:30</end-time>
<duration>00:30</duration>

</program>
<program>

<station>WKPL</station>
<rf-channel>7</rf-channel>
<tv-mode>analog</tv-mode>
<program-title>Friends</program-title>
<program-description>

Description, if any, goes here.

</program-description>
<start-date>20010512</start-date>
<start-time>18:00</start-time>
<end-date>20010512</end-date>
<end-time>18:30</end-time>
<duration>00:30</duration>

</program>

</tv-program-info>

Throughout this description, a standardized document is meant to refer to a document form that has been agreed upon by the guide provider and one or more PVR software providers. It does not imply that the document format has been adopted by a Standards body (although it does not preclude such adaptation).

Throughout this description, reference is made to a television programming, because it is believed that the beneficial aspects of the present invention would be most readily apparent when used in connection with such programming; however, it should be understood that the present invention is not intended to be so limited and should be hereby construed to include other content, such as FM radio, digital cable radio, datacasts, etc.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

We claim:

1. An electronic programming guide system comprising:
a browser on a first PC at a first viewer location;
a computer system at a second location, coupled to said browser via a computer network;
said browser displaying a guide comprising a plurality of cells wherein information representative of said guide is transmitted from said second location;
where each of said plurality of cells is associated with a particular program and contains text relating to said particular program; and,
where each of said plurality of cells further includes a link which is coupled to software which upon activation of said link, causes a standardized document to be provided to a recorder, where the recorder utilizes said standardized document to schedule recording of said particular program.

2. A system of claim 1 further comprising:
a programming source which provides video signals over an internet connection;
where said software links said guide to said programming source.

3. A system of claim 2 wherein said video signals are recorded on said first PC.

4. A system of claim 1 further comprising:
a PCTV board disposed in said first PC which tunes video signals;
where said software links said guide to said PCTV board.

5. A system of claim 4 wherein said PCTV board receives signals from a broadcast television antenna.

6. A system of claim 4 wherein said PCTV board receives signals from a coaxial antenna cable coupled to a source of CATV.

7. A system of claim 1 further comprising:
wherein said recorder is a video cassette recorder which tunes video signals and which further communicates with said first PC via a first control signal; and
where said software links said guide to said video cassette recorder.

8. A system of claim 7 wherein said video cassette recorder receives signals from a broadcast television antenna.

9. A system of claim 7 wherein said video cassette recorder receives signals from a coaxial antenna cable coupled to a source of CATV and wherein said first control signal is an infra red signal formatted in compliance with a predetermined standard for communication between a video cassette recorder and a handheld remote control device.

10. A method of scheduling recording of programming, comprising the steps of:
providing, via a computer network, an electronic programming guide to a first PC;
activating a link in said guide; and,
in response to said step of activating, delivering, via said computer network, a standardized scheduling document to said first PC, such that said standardized scheduling document is used to schedule recording of programming.

11. A method of claim 10 wherein said step of delivering, via said computer network, a standardized document to said first PC, comprises a step of generating a standardized document having a standardized MIME type and containing information therein relating to a start time and a channel of a television program to be recorded.

12. A method of claim 11 wherein said standardized document is in an XML format.

13. A method of claim 10 wherein said computer network is an internet.

14. A method of claim 10 wherein said computer network is a local area network which comprises a home system where there is an in-home programming server configured for serving an in-home recording device.

15. A system comprising:
a server, coupled to a computer network;
said server providing a programming guide comprising a plurality of cells wherein information representative of said programming guide is transmitted from said server, via said computer network;
where each of said plurality of cells is associated with a particular program and contains text relating to said particular program; and,
where each of said plurality of cells further includes a link which, upon activation of said link, causes a standardized document to be provided to a recorder, where the recorder utilizes said standardized document to schedule a recording of said particular program.

16. A system of claim 15 wherein said computer network is an internet.

17. A system of claim 15 wherein said computer network is a local area network.

18. A system of claim 15 wherein said recorder is a video recorder and wherein said plurality of cells is arranged in rows and columns.

19. An electronic programming guide system comprising:
a browser on a first PC at a first viewer location;
a computer system at a second location, coupled to said browser via a computer network;
said browser displaying a guide comprising a plurality of cells wherein information representative of said guide is transmitted from said second location;
where each of said plurality of cells is associated with a particular program and contains text relating to said particular program; and, where each of said plurality of cells further includes a link which is coupled to software which upon activation of said link, causes a standardized document to be provided to a viewer application, where the viewer application utilizes said standardized document to display said particular program.

20. A system of claim 19 further comprising:
a programming source which provides video signals over an internet connection;
where said software links said guide to said programming source; and
where said plurality of cells are arranged in rows and columns.

21. A system of claim 20 wherein said video signals are displayed on said first PC for immediate review.

22. A system of claim 19 further comprising:
a PCTV board disposed in said first PC which tunes video signals;
where said software links said guide to said PCDT board; and
where said plurality of cells are arranged in rows and columns.

23. A system of claim 22 wherein said PCDT board receives signals from a broadcast television antenna.

24. A system of claim 22 wherein said PCDT board receives signals from a coaxial antenna cable coupled to a source of CATV.

25. A method of recording information, comprising the steps of:
providing, via a computer network, a programming guide to a first PC;
activating a link in said guide; and,
in response to said step of activating, delivering, via said computer network, a standardized scheduling document to said first PC, such that said standardized scheduling document is used to schedule recording of said information.

26. A method of claim 25 wherein said step of delivering, via said computer network, a standardized document to said first PC, comprises a step of generating a standardized document having a standardized MIME type and containing information therein relating to a broadcast frequency of a radio program to be recorded.

27. A method of claim 26 wherein said standardized document is in an XML format.

28. A method of claim 27 wherein said computer network is an internet.

29. A system of claim 1 wherein said recorder is a video recorder and where said plurality of cells are arranged in rows and columns.
